(19) United States
(12) Patent Application Publication
(10) Pub. No.: US 2025/0068963 A1
(43) Pub. Date: Feb. 27, 2025

(54) DATA IMPACT QUANTIFICATION IN MACHINE UNLEARNING

(71) Applicant: International Business Machines Corporation, Armonk, NY (US)

(72) Inventors: Bing Zhang, San Jose, CA (US); Shubhi Asthana, San Jose, CA (US); PAWAN RAGHUNATH CHOWDHARY, SAN JOSE, CA (US)

(21) Appl. No.: 18/455,659

(22) Filed: Aug. 25, 2023

(51) Int. Cl. G06N 20/00

(52) U.S. Cl. CPC G06N 20/00

(57) ABSTRACT

Aspects of the invention include techniques for quantifying the impact of data removal in machine unlearning. A non-limiting method includes receiving a data removal request identifying, for removal, a specific subset of data from an original training data set. An optimal model is built by minimizing a prediction error over the original training data set and a loss function is determined that measures a difference between a first prediction of the optimal model when trained with the original training data set and a known ground truth. An impact factor is determined that measures a difference between the first prediction of the optimal model and a second prediction of the optimal model when trained with a sanitized training data set against the known ground truth. A machine unlearning model is fine-tuned on the impact factor to quantify a data removal impact.

### BACKGROUND

The present invention generally relates to data privacy, control, and machine learning, and more specifically, to computer systems, computer-implemented methods, and computer program products for quantifying the impact of data removal in machine unlearning.

Data privacy regulations such as the General Data Protection Regulation (GDPR) and the California Consumer Privacy Act (CCPA) have heightened concerns regarding data ownership, data privacy, and the rights of individuals to request the removal of their personal information. These regulations, and others, grant individuals the right to request the deletion of their private and sensitive information held by businesses. This requirement can extend to machine learning models that may have been trained on such data.

Machine unlearning is an emerging concept designed to address the intricate challenge of retracting the influence of specific training data from a pre-trained machine learning model. The goal of machine unlearning is to remove all traces of a particular person or data point(s) from a machine learning system, without affecting its performance. In particular, machine unlearning involves undoing the effect on a model from a specific subset of data used for training the model and retraining the model effectively on the retained data. In other words, machine unlearning involves reversing the impact of selected data subsets, enabling models to effectively “unlearn” the information associated with these subsets while maintaining their overall functionality and predictive capabilities. Machine unlearning is vital across a range of scenarios, such as where individuals request data removal due to privacy regulations or where certain data has become obsolete or undesirable.

### SUMMARY

Embodiments of the present invention are directed to techniques for quantifying the impact of data removal in machine unlearning. A non-limiting example method includes receiving a data removal request identifying, for removal, a specific subset of data from an original training data set. An optimal model is built by minimizing a prediction error over the original training data set and a loss function is determined that measures a difference between a first prediction of the optimal model when trained with the original training data set and a known ground truth. An impact factor is determined that measures the difference between the first prediction of the optimal model and a second prediction of the optimal model when trained with a sanitized training data set against the known ground truth. A machine unlearning model is fine-tuned on the impact factor to quantify a data removal impact.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computing environment for use in conjunction with one or more embodiments;

FIG. 2 depicts a block diagram of an example machine unlearning system architecture in accordance with one or more embodiments;

FIG. 3 depicts a block diagram of an example data impact architecture in accordance with one or more embodiments;

FIG. 4 depicts a block diagram of an example machine unlearning module in accordance with one or more embodiments;

FIG. 5 depicts a block diagram of an example data removal request pool in accordance with one or more embodiments; and

FIG. 6 is a flowchart in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted, or modified.

In the accompanying figures and following detailed description of the described embodiments of the invention, the various elements illustrated in the figures are provided with two or three-digit reference numbers. With minor exceptions, the leftmost digit(s) of each reference number corresponds to the figure in which its element is first illustrated.

### DETAILED DESCRIPTION

Machine learning models are sophisticated systems that learn patterns and make predictions or decisions based on data. Machine learning models have witnessed substantial advancements due to their ability to uncover complex relationships when trained at scale with large data sets. In short, the efficacy of these models hinges on the quality, quantity, and diversity of the data they are trained on, where larger data sets often lead to enhanced model accuracy and generalization capabilities. Scenarios can occur, however, in which some subset of data must be scrubbed from a trained model. For example, a customer might request the removal of their data, data from a local jurisdiction might need to be removed from a global model due to changes in data ownership rules within that jurisdiction, and/or data mistakenly imported and included within a training data set might need to be removed.

There are a variety of approaches to data removal in the context of machine learning. A first class of approaches, the so-called naïve approach, involves some combination of data pre/post-processing to sanitize the training data, such as by removing all data and retraining from scratch on the sanitized data and/or applying censorship rules and systems on the model outputs. These types of systems guarantee data removal, but at considerable retraining and accuracy costs. Differential Privacy (DP) methods represent another class of approaches where the effect of an individual data input on the output of a specific function is bounded (i.e., DP provides guarantees on bounds ensuring the contribution from the data points is as low as possible). Training models with DP suffers from substantial performance gaps, expensive computation, and slow convergence. Furthermore, DP can only provide limited guarantees for models because DP requires a unified definition for privacy boundaries.

Machine unlearning refers generally to yet another variety of approaches to remove the influence of a specified subset of training data, upon request, from a trained model. Rather than retraining from scratch on sanitized data (as in the naïve approach) or placing bounds on data influence (as in the DP approach), machine unlearning focuses on removing (unlearning) the influence of specific data from the model, in short, by ensuring that there is zero contribution of the training samples to the so-called unlearned model. While machine unlearning systems have been found to effectively remove the influence of specific target data points from a trained model, current machine unlearning approaches do not actually quantify the impact of said data removal on the unlearned model. In other words, the nexus between unlearning over a particular data subset and the subsequent changes in model performance are lost or otherwise unaccounted for.

This disclosure introduces new methods, computing systems, and computer program products for quantifying the impact of data removal in machine unlearning. A new machine learning architecture is proposed for estimating an impact factor R for an unlearning request. In some embodiments, the impact factor R quantifies the impact of updating, removing, and unlearning data (points or sets) and/or data features on the unlearned model. In some embodiments, the impact factor R is based on a loss function which measures a prediction difference between the predictions of a so-called optimal model trained with full data (i.e., the original data set) and the optimal model with sanitized data (i.e., data with value change, feature change, and/or conversion degree) against a known ground truth. The optimal model can be found by minimizing the prediction error over the original data (e.g., by minimizing regularized empirical risk).

In some embodiments, the impact factor R is used to fine-tune a base foundational model, such as a Sharded, Isolated, Sliced, Aggregated (SISA) unlearning model. In a SISA unlearning model, data is divided into shards (also referred to as partitions), which are themselves divided into slices. One constituent model M_{S} is trained on each shard by presenting it with incrementally many slices and saving its parameters before the training set is augmented with a new slice. Advantageously, when data needs to be unlearned, only one of the constituent models M_{S} whose shards contains the data/point to be unlearned needs to be retrained. In other words, retraining can start from the last parameter values saved before the slice containing the data point to be unlearned was included.

Building a data impact quantification architecture in accordance with one or more embodiments described herein offers various technical advantages over prior machine unlearning approaches. In particular, the impact factor R can be leveraged to fine-tune conventional SISA unlearning models so that those models can quantify the impact of data removal (SISA unlearning models do not natively quantify the impact of data removal). In some embodiments, a normalized data impact factor R is determined for each constituent model M_{S} in a SISA training regime and these normalized values are used as the weights for the respective models Ms.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

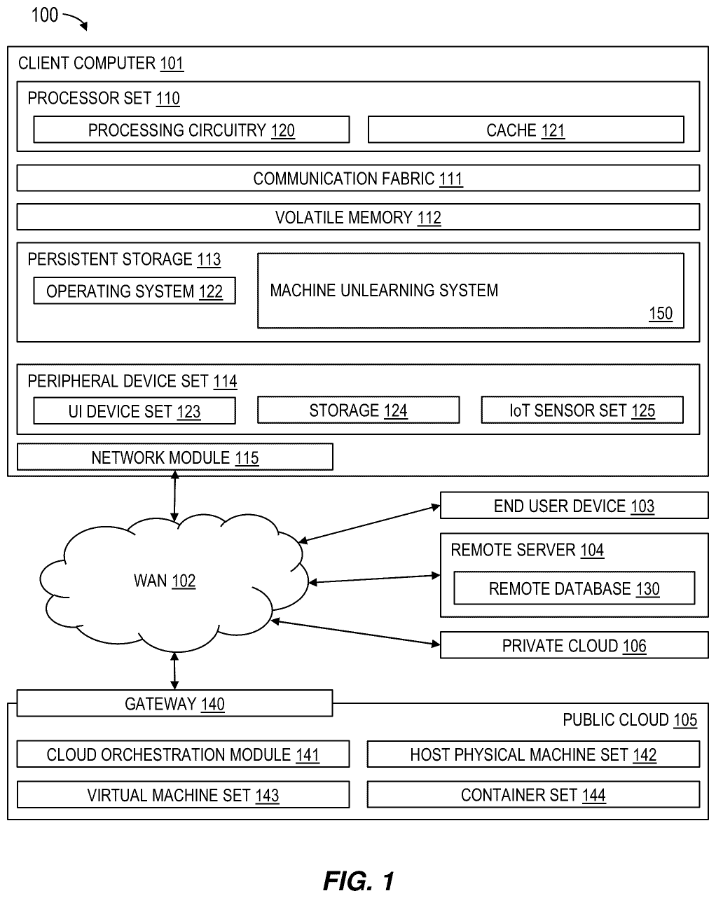

Referring now to FIG. 1, computing environment 100 contains an example of an environment for the execution of at least some of the computer code and a subsystems architecture involved in performing the inventive methods, such as machine unlearning system 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

It is to be understood that the block diagram of FIG. 1 is not intended to indicate that the computing environment 100 is to include all of the components shown in FIG. 1. Rather, the computing environment 100 can include any appropriate fewer or additional components not illustrated in FIG. 1 (e.g., additional memory components, embedded controllers, modules, additional network interfaces, etc.). Further, the embodiments described herein with respect to the computing environment 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

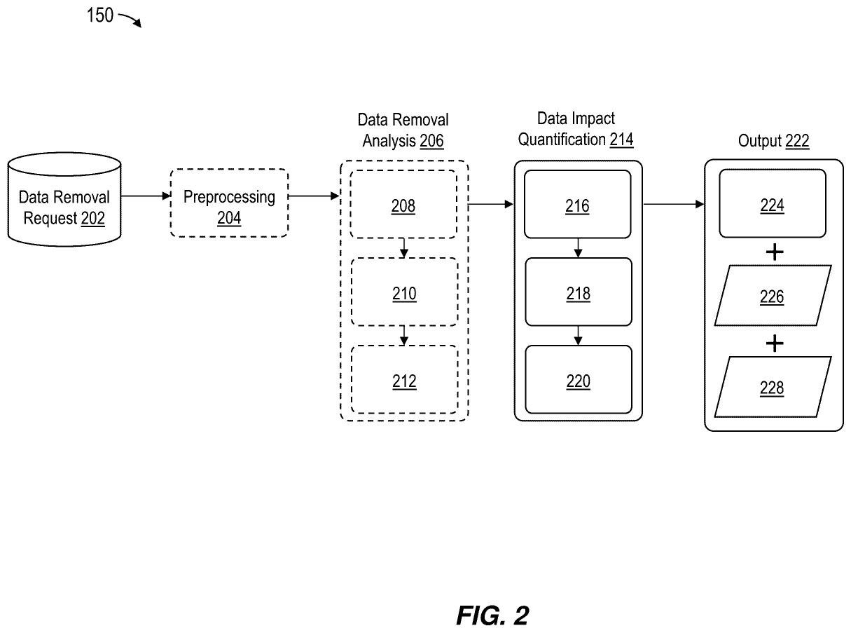

FIG. 2 illustrates a block diagram of an example machine unlearning system architecture (e.g., the machine unlearning system 150 of FIG. 1) in accordance with one or more embodiments. As shown in FIG. 2, the machine unlearning system 150 includes a data removal request 202. In some embodiments, the data removal request 202 identifies a specific subset {dᵤ} of training data D+{dᵤ} for removal from a trained model.

### Data Removal Request Preprocessing

In some embodiments, the data removal request 202 is received by a data removal request preprocessing subsystem (here, preprocessing 204) of the machine unlearning system 150. In some embodiments, the data removal request preprocessing subsystem is bypassed (i.e., preprocessing 204 is optional).

In some embodiments, preprocessing 204 includes documenting the data removal request 202 and the specific subset {dᵤ} marked for removal/deletion. In some embodiments, preprocessing 204 includes evaluating whether the data removal request 202 and/or the specific subset {dᵤ} are valid. In some embodiments, valid requests and data are approved for removal. In some embodiments, invalid requests and data are not approved for removal and/or are marked for further analysis.

In some embodiments, data removal validity is determined according to one or more predetermined rules. For example, removal criteria can include the frequency of sending removal requests by the source, the urgency of the request, the time required to input new data into the system, and the life cycle of the specific subset {dᵤ} marked for removal.

In some embodiments, high frequency removal requests (i.e. spammed requests) are assigned a lower priority than low frequency removal requests. In some embodiments, the urgency of the request includes identifying whether there is a lag time and/or period constraint for taking action. In some embodiments, relatively urgent requests are prioritized over relatively less urgent requests. In some embodiments, the time required to input new data into the system can be considered as a factor for validity and/or a timeline for deletion. For example, if an estimated time required to input new data (replacement data) into the system is relatively long, data removal can proceed after a delay period. The delay period can accommodate the estimated time (with or without additional margins) to input new data. In some embodiments, data removal validity takes into account the life cycle of the specific subset {dᵤ} marked for removal. For example, if the specific subset {dᵤ} marked for removal includes data that will reach end of life natively within a predetermined window of the data removal request 202, the request can be marked invalid (e.g., the data will be deprecated and/or decommissioned within the time period for processing the removal).

### Data Removal Analysis

In some embodiments, the data removal request 202 and/or the results from preprocessing 204 can be forwarded to a data removal analysis subsystem (here, data removal analysis 206) of the machine unlearning system 150. In some embodiments, the data removal analysis subsystem is bypassed (i.e., data removal analysis 206 is optional).

In some embodiments, data removal analysis 206 includes a data gathering process 208. In some embodiments, the data gathering process 208 includes counting the amount (size, scope) of the specific subset {dᵤ} marked for removal. In some embodiments, a size N of the original training data is determined. In some embodiments, a number of data points n in N to be removed is determined. In some embodiments, a total number of data features M included in the underlying model is determined. Data features M can be well-structured numeric and/or text data and/or the unstructured textual sections and/or clauses within a document. In some embodiments, a number of data features m in M to be removed is determined.

In some embodiments, data removal analysis 206 includes importance estimation 210. In some embodiments, importance estimation 210 includes calculating a data feature importance score Fi (i=1, 2, . . . , m). In some embodiments, data features M are individual properties generated from a data set (e.g., D+{dᵤ}) and used as input to models. In some embodiments, the data feature importance score Fᵢ determines the degree of usefulness of a specific variable (e.g., a data feature m) for a current model. In some embodiments, the data feature importance score Fᵢ quantifies a relevancy of data feature i (i in m) to the model. In some embodiments, the data feature importance score Fᵢ is determined according to permutation feature importance (i.e., observe how predictions of a machine unlearning model change when we change the values of a single variable) according to Algorithm 1.

Algorithm 1: Permutation Feature Importance

At first, calculate MSE, accuracy, or any other metric M using the
model's predictions with all features.
for each feature F do

| | |
|---|---|
| \| | Shuffle the values of a feature F. |
| \| | Make new predictions with shuffled values and calculate chosen |
| \| | metric M_{F}. |
| \| | Calculate difference D_{F} between M and M_{F} for a current |
| \|_{—} | feature F and save it. |

At last, sort the differences D_{F} to get the most important features.

In some embodiments, data removal analysis 206 includes data conversion scoring 212. In some embodiments, data conversion scoring 212 includes analyzing a data structure conversion (e.g., the steps to perform unstructured data to structured data conversion within the scope of a removal request).

In some embodiments, analyzing a data structure conversion involves a sequence of steps. In some embodiments, step 1 includes cleaning the unstructured data (e.g., an image, a table, etc.). In some embodiments, step 2 includes selecting technology for data collection and storage (e.g., IOCR). In some embodiments, step 3 includes one or more of entity extraction, sentence extraction, and semantic analysis. For example, unstructured data can be processed using known Natural Language Processing (NLP) techniques. In some embodiments, step 4 includes creating a pattern or format of data view. In some embodiments, step 5 includes analyzing the data. In some embodiments, step 6 includes developing a roadmap to rank and score a conversion between a source unit of measure and a target unit of measure. For example, rank and score can include determining whether the source unit of measure (e.g., labels, such as the trend, effect, cause, amount, date, format etc., of the unstructured data) are well converted to the target unit of measure (structured data). In some embodiments, step 7 includes computing the λ score average weighted by all the labels' convention scores. λ scores can be determined using known techniques. In some embodiments, a score, λ, of each data conversion process is generated based on a conversion degree of valid information.

### Data Impact Quantification Mechanism for Machine Unlearning

In some embodiments, the data removal request 202 and/or the results from the data removal analysis 206 and/or the results from preprocessing 204 can be forwarded to a data impact quantification subsystem (here, data impact quantification 214) of the machine unlearning system 150.

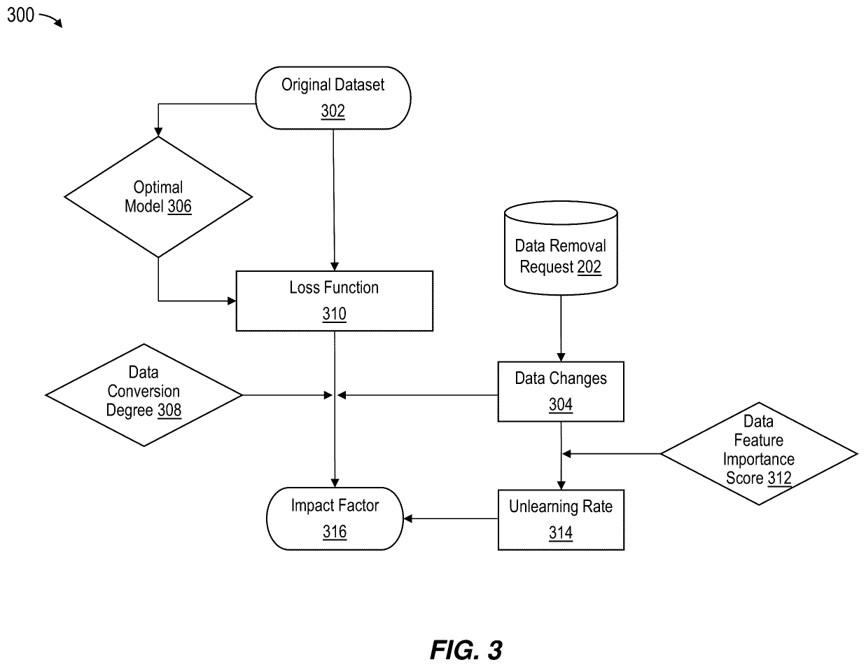

In some embodiments, data impact quantification 214 includes a data impact process 216. In some embodiments, the data impact process 216 includes determining a data impact factor R. Determining the data impact factor R is discussed in greater detail with respect to FIG. 3.

FIG. 3 illustrates a block diagram of an example data impact architecture 300 for the data impact process 216 of FIG. 2 in accordance with one or more embodiments. As shown in FIG. 3, the data removal request 202 is combined with an original data set 302 (also referred to as an original training data set, e.g., training data D+{dᵤ}) to define an updated data set (also referred to as a sanitized training data set, e.g., training data D). In some embodiments, the original data set 302 can be described as Z={z₁, . . . , z_{q}}={x₁, . . . ,xₙ; y₁, . . . , yₘ} for each data zᵢ=(xₖ; yⱼ), consisting of numeric values x∈X, and features y∈Y. In some embodiments, the updated data can be described as \tilde{Z}={\tilde{z}₁, . . . , \tilde{z}ₚ}, \tilde{z}=(x+δₓ, y+δ_{y}), where δy and δx are the data changes 304 in {dᵤ} that have been requested to be removed from zᵢ=(x,y) (i.e., these variables denote the effects of the data removal request 202 on the original data set 302). In some embodiments, data changes 304 (e.g., δy and δx) affect the computation of an impact factor (refer below) in two ways: via an updated loss function and via an unlearning rate. The impact factor, loss function, and unlearning rate are discussed in greater detail below.

In some embodiments, the original data set 302 is leveraged to define an optimal model 306. In some embodiments, the optimal model 306 (also referred to as “θ*”) can be found by minimizing a regularized empirical risk according to Equation (1).

$${θ}^{*} = arg min ( θ ) {\sum }_{i = 1}^{q} l ( {z}_{q} , θ ) \qquad ( 1 )$$

In some embodiments, the original data set 302 and the optimal model 306 are leveraged to determine a loss function 310. In some embodiments, the loss function 310 measures a difference between a prediction(s) of an optimal learning model θ* (trained with full data) and a known ground truth.

In some embodiments, the data changes 304 are leveraged to define an unlearning rate 314 (also referred to as “τ”). Intuitively, the unlearning rate 314 will be a relatively small constant due to the data changes 304 shifting the model parameters from Σ_{z∈Z}∇_{θ}l(z, θ*) to Σ_{\tilde{z}∈\tilde{Z}}∇_{θ}l(\tilde{z}, θ*), where the size of the update step is determined by the data removal rate

$$τ = f ( \frac{n}{N} )$$

and/or data feature removal rate

$$τ = {F}_{i} * f ( \frac{m}{M} ) ,$$

where Fᵢ (i=1, 2, . . . , m) is a data feature importance score 312 (as described in importance estimation 210).

In some embodiments, the loss function 310, a data conversion degree 308 (λ, determined as discussed previously with respect to data conversion scoring 212), the data changes 304, and the unlearning rate 314 are leveraged to determine an impact factor 316 (also referred to as impact factor R). In some embodiments, the impact factor 316 is determined according to Equation (2).

$$Ri = Δ ( Z , \tilde{Z} ) = τ ( {\sum }_{\tilde{z} ∈ \tilde{Z}} {∇}_{θ} l ( λ \cdot \tilde{z} , {θ}^{*} ) - {\sum }_{z ∈ Z} {∇}_{θ} l ( z , {θ}^{*} ) ) \qquad ( 2 )$$

In some embodiments, the impact factor 316 quantifies a difference between the prediction(s) of the optimal learning model θ* trained with full data vs. the prediction(s) of an optimal learning model θ trained with sanitized data against a known ground truth and a known ground truth. In some embodiments, the impact factor 316 is stored (e.g., as a library) for each removal request, so that the known impact factor 316 can be leveraged for future requests having predetermined shared characteristics with the data removal request 202 (i.e., for those future requests where the impact on machine unlearning should be expected to be similar to that already determined). In this manner, computational time is reduced.

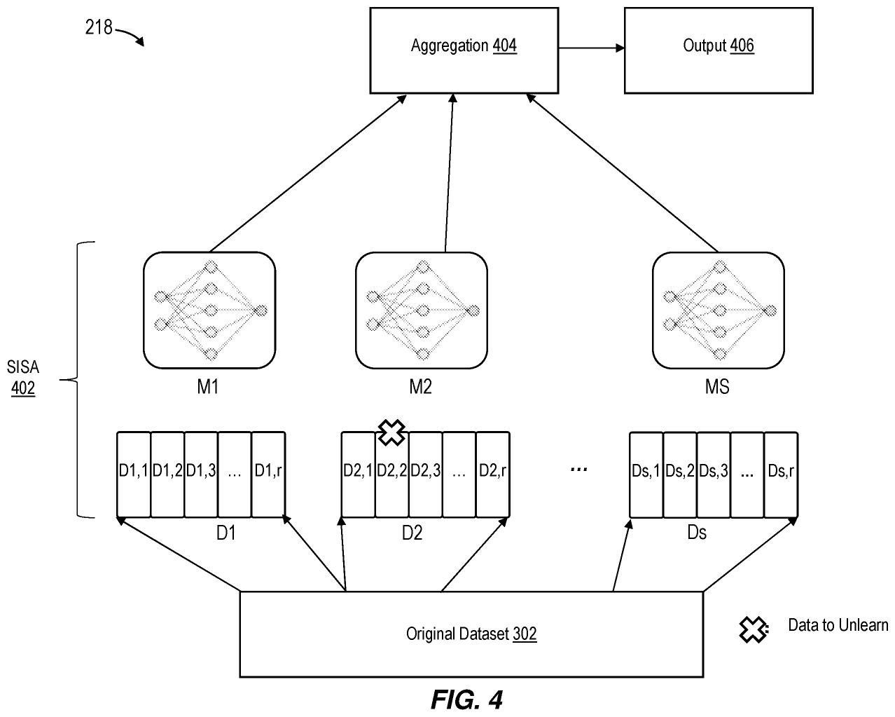

Returning again to FIG. 2, in some embodiments, data impact quantification 214 includes a machine unlearning module 218 for building and fine-tuning a machine unlearning model. In some embodiments, the machine unlearning module 218 includes training the machine unlearning model. Building, training, and fine-tuning a machine unlearning model is discussed in greater detail with respect to FIG. 4.

FIG. 4 illustrates a block diagram of an example machine unlearning module 218 in accordance with one or more embodiments. As shown in FIG. 4, a SISA unlearning model (here, SISA 402) divides the original data set 302 into s data splits (here, D₁, D₂, . . . , D_{S}, where D_{S} is the “s^{th}” data split). Further, each of the data splits is further split into r slices (here, D_{1,1}, D_{1,2}, . . . , D_{1,r}; D_{2,1}, D_{2,2}, . . . , D_{2,r}; . . . ; D_{S,1,}D_{S,2,}. . . , D_{S,r}, where D_{S,r} is the “r^{th}” slice in the “s^{th}” data split). Finally, the models M_{S} denote the s^{th} constituent model of the SISA 402.

In some embodiments, each of the models M_{S} are trained to output a prediction based on input data. Observe that, by construction, the models M_{S} are trained only over their respective data split. The models M_{S} can be trained using known machine learning and SISA techniques. In some embodiments, the SISA architecture includes an aggregation 404 of the outputs of the various models M_{S}. The outputs can be aggregated using known SISA techniques. In some embodiments, the aggregation 404 is leveraged to provide an overall output 406 (e.g., a final model prediction).

In some embodiments, the original data set 302 must be modified after the SISA 402 is trained. For example, a specific subset {dᵤ} of the original data set 302 can be marked for removal as discussed previously herein (here, a stylized “X” denotes “D_{2,2}” as data to unlearn).

In some embodiments, the impact factor 316 (refer to FIG. 3) is leveraged to fine-tune the SISA 402 to be able to quantify the data removal impact caused by the removal of the specific subset {dᵤ}. In some embodiments, fine-tuning the SISA 402 includes calculating a data impact factor Rᵢ of each data set to unlearn. For example, calculating a data impact factor Rᵢ for the D_{2,2} slice. The data impact factors Rᵢ can be determined according to Equation (2).

Observe that, by definition, the factor of a data split without “data to unlearn” is “1” (no impact as the data is retained). In some embodiments, the impact factors Rᵢ are applied as weights to each respective constituent model M_{S} when fine-tuning the SISA 402. In this manner, the higher a respective data removal impact is, the higher it's respective effect (via weight) is on the SISA 402. In some embodiments, the impact factors Rᵢ of each data split D_{S} are normalized. In some embodiments, the normalized values for the impact factors Rᵢ are applied as the weights.

Returning again to FIG. 2, in some embodiments, data impact quantification 214 includes a comparative analysis on the machine unlearning accuracy with the data removal request (here, comparative analysis 220). In some embodiments, comparative analysis 220 includes evaluating the machine unlearning model prediction accuracy on different data removal requests. A variety of methods are known for evaluating model prediction accuracy. For example, in some embodiments, comparative analysis 220 includes calculating a prediction accuracy using Mean Absolute Percentage Error (MAPE), although other accuracy measuring/error functions are within the contemplated scope of this disclosure (e.g., a Markov chain Monte Carlo-based machine unlearning (MCU) algorithm can be used to explain the effect of a data removal on model predictions). In some embodiments, MAPE can be determined according to Equation (3).

$$MAPE = Avg ( \frac{Abs ( Actual - Forecast )}{Abs ( Actual )} ) * 100 \qquad ( 3 )$$

### Insight, Recommendations, and Data Removal

In some embodiments, the results from the data impact quantification 214 can be leveraged to generate an output 222. The output 222 can include an action and recommendation mechanism 224 and/or removal metrics (e.g., an actual impact 226 on data removal, an urgency 228 of data removal, etc.).

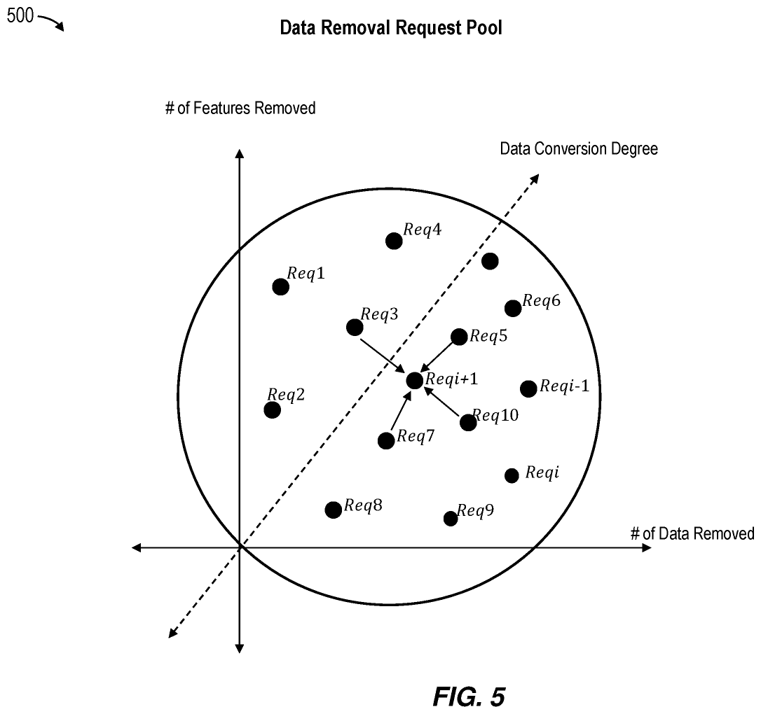

In some embodiments, the action and recommendation mechanism 224 includes reassessing machine unlearning model performance. In some embodiments, a data pool of data removal requests is built. In some embodiments, the impact factor R and the corresponding tuned model accuracy (e.g., MAPE as described previously) are computed. In some embodiments, when a new data removal request (e.g., Reqᵢ₊₁) is received by the machine unlearning system 150, a K-Nearest neighbors (KNN) algorithm is leveraged to find a closeness in a data removal request pool (refer to FIG. 5) to an existing request (stored, e.g., in a library as discussed previously with respect to the impact factor R). In some embodiments, the learning/output from the existing requests is reused, that is, their R and MAPE can be recycled, to provide insights into this new data removal request. In some embodiments, an acceptable machine unlearning model error threshold can be set for these comparisons (e.g., as Eₗ, Eₕ).

In some embodiments, the action and recommendation mechanism 224 further includes a policy module (not separately shown). For example, the policy module can be configured to consider predetermined policies. In some embodiments, the policy module is configured to consider a lag time (also referred to as a valid request period, T_{lag}), an urger period of a data removal request, T_{urgent}, and/or a time of importing new data into the system, Tᵢₘₚₒᵣₜ.

In some embodiments, the action and recommendation mechanism 224 further includes a mechanism to provide insights on the data removal task. In some embodiments, the action and recommendation mechanism 224 is configured to take a set of actions A to determine the viability of an action(s) recommended. For example, when MAPE>Eₕ, the set of actions A can include flagging/notifying a requesting party (e.g., a user, customer, etc.) that the data will not be removed. In some embodiments, the set of actions A includes a recommended time to remove the data. For example, the set of actions A can include a recommendation to remove in T_{urgent} days, when Eₗ<MAPE<Eₕ and T_{urgent}<Tᵢₘₚₒᵣₜ<T_{lag}. In another example, the set of actions A can include a recommendation to remove in Tᵢₘₚₒᵣₜ days, when Eₗ<MAPE<Eₕ and Tᵢₘₚₒᵣₜ<T_{urgent}<T_{lag}. In another example, the set of actions A can include a recommendation to remove in T_{lag} days, when Eₗ<MAPE<Eₕ and T_{lag}<Tᵢₘₚₒᵣₜ and T_{lag}<T_{urgent}. In some embodiments, the set of actions A can include a recommendation to remove when MAPE<Eₗ. In some embodiments, the action and recommendation mechanism 224 is configured to determine a set of states S which are indicative of prior and post actions A when actions are taken upon the state with feature/parameters at a given time instant T. In some embodiments, the action and recommendation mechanism 224 is configured to determine a reward Rₑ. In some embodiments, the reward Rₑ is a function directly proportional to the change in model performance and business criteria according to Equation (4).

$${R}_{e} = \sum f ( A , S ) \qquad ( 4 )$$

In some embodiments, the action and recommendation mechanism 224

includes completing the data removal request 202. For example, the action and recommendation mechanism 224 can include removing the specific subset {dᵤ} from the original data set 302 (i.e., the data can be scrubbed).

FIG. 5 illustrates an example data removal request pool 500 in accordance with one or more embodiments. As shown in FIG. 5, a data removal request pool can encode a relationship (here, “a data conversion degree”) between the number of features removed (the Y-axis) and the number of data removed (the X-axis) across a number of requests (here, requests Req₁, Req₂, . . . , Reqᵢ₋₁, Reqᵢ, Reqᵢ₊₁). As further shown in FIG. 5, the 4-nearest neighbors Req₃, Req₅, Req₇, and Reg₁₀ have been identified for the new request Reqᵢ₊₁ as discussed previously with respect to the action and recommendation mechanism 224. It should be understood that the “4” nearest neighbors are illustrative only, and that the value for “K” (i.e., the KNN) can be set as desired in a given application. Moreover, acceptable machine unlearning model error thresholds (e.g., Eₗ, Eₕ) can be set as desired to place constraints on the acceptable deltas between the number of features removed and/or the number of data removed.

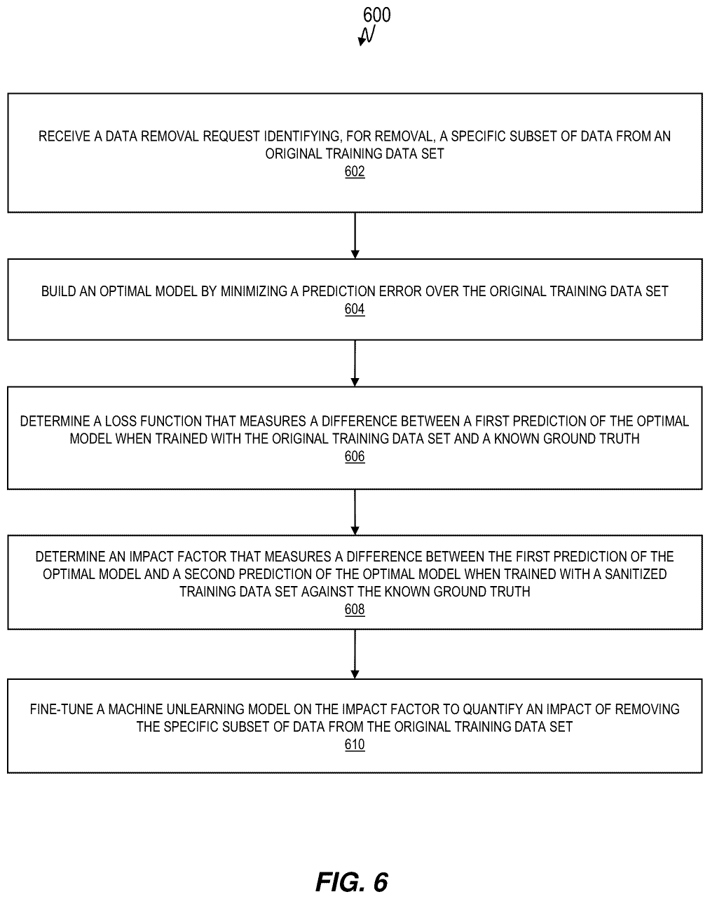

Referring now to FIG. 6, a flowchart of a method 600 for quantifying the impact of data removal in machine unlearning is generally shown according to an embodiment. The method 600 is described in reference to FIGS. 1-5 and may include additional blocks not depicted in FIG. 6. Although depicted in a particular order, the blocks depicted in FIG. 6 can be rearranged, subdivided, and/or combined. In exemplary embodiments, the method 600 can be performed by a computing environment (e.g., computing environment 100 shown in FIG. 1).

At block 602, the method includes receiving a data removal request identifying, for removal, a specific subset of data from an original training data set.

At block 604, the method includes building an optimal model by minimizing a prediction error over the original training data set. In some embodiments, minimizing the prediction error over the original data includes minimizing a regularized empirical risk.

At block 606, the method includes determining a loss function that measures a difference between a first prediction of the optimal model when trained with the original training data set and a known ground truth.

At block 608, the method includes determining an impact factor that measures a difference between the first prediction of the optimal model and a second prediction of the optimal model when trained with a sanitized training data set against the known ground truth. In some embodiments, the sanitized training data set includes the remaining data after removing the specific subset of data from the original training data set.

At block 610, the method includes fine-tuning a machine unlearning model on the impact factor to quantify an impact of removing the specific subset of data from the original training data set.

In some embodiments, the machine unlearning model is a sharded, isolated, sliced, aggregated (SISA) unlearning model. In some embodiments, the SISA unlearning model divides the original training data set into s data splits. In some embodiments, each of the s data splits are further split into r slices. In some embodiments, the SISA unlearning model includes a plurality of constituent models M_{S}, each trained on a unique slice (e.g., a slice r).

In some embodiments, the specific subset of data marked for removal includes data on at least one slice of the SISA unlearning model.

In some embodiments, fine-tuning the machine unlearning model includes determining a data impact factor Rᵢ for each slice having data from the specific subset of data marked for removal. In some embodiments, each of the data impact factors Rᵢ for each respective slice having data of the specific subset of data are applied as weights to a respective constituent model M_{S} when fine-tuning the SISA unlearning model.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A computer-implemented method comprising:
receiving a data removal request identifying, for removal, a specific subset of data from an original training data set;
building an optimal model by minimizing a prediction error over the original training data set;
determining a loss function that measures a difference between a first prediction of the optimal model when trained with the original training data set and a known ground truth;
determining an impact factor that measures a difference between the first prediction of the optimal model and a second prediction of the optimal model when trained with a sanitized training data set against the known ground truth, wherein the sanitized training data set comprises remaining data after removing the specific subset of data from the original training data set; and
fine-tuning a machine unlearning model on the impact factor to quantify an impact of removing the specific subset of data from the original training data set.

2. The computer-implemented method of claim 1, wherein minimizing the prediction error over the original data comprises minimizing a regularized empirical risk.

3. The computer-implemented method of claim 1, wherein the machine unlearning model comprises a sharded, isolated, sliced, aggregated (SISA) unlearning model.

4. The computer-implemented method of claim 3, wherein the SISA unlearning model divides the original training data set into s data splits, wherein each of the s data splits are further split into r slices, and wherein the SISA unlearning model comprises a plurality of constituent models M_{S}, each trained on a unique slice.

5. The computer-implemented method of claim 4, wherein the specific subset of data comprises data on at least one slice of the SISA unlearning model.

6. The computer-implemented method of claim 5, wherein fine-tuning the machine unlearning model comprises determining a data impact factor Rᵢ for each slice comprising data of the specific subset of data.

7. The computer-implemented method of claim 6, wherein each of the data impact factors Rᵢ for each respective slice comprising data of the specific subset of data are normalized and applied as a weight to a respective constituent model M_{S} when fine-tuning the SISA unlearning model.

8. A system having a memory, computer readable instructions, and one or more processors for executing the computer readable instructions, the computer readable instructions controlling the one or more processors to perform operations comprising:
receiving a data removal request identifying, for removal, a specific subset of data from an original training data set;
building an optimal model by minimizing a prediction error over the original training data set;
determining a loss function that measures a difference between a first prediction of the optimal model when trained with the original training data set and a known ground truth;
determining an impact factor that measures a difference between the first prediction of the optimal model and a second prediction of the optimal model when trained with a sanitized training data set against the known ground truth, wherein the sanitized training data set comprises remaining data after removing the specific subset of data from the original training data set; and
fine-tuning a machine unlearning model on the impact factor to quantify an impact of removing the specific subset of data from the original training data set.

9. The system of claim 8, wherein minimizing the prediction error over the original data comprises minimizing a regularized empirical risk.

10. The system of claim 8, wherein the machine unlearning model comprises a sharded, isolated, sliced, aggregated (SISA) unlearning model.

11. The system of claim 10, wherein the SISA unlearning model divides the original training data set into s data splits, wherein each of the s data splits are further split into r slices, and wherein the SISA unlearning model comprises a plurality of constituent models M_{S}, each trained on a unique slice.

12. The system of claim 11, wherein the specific subset of data comprises data on at least one slice of the SISA unlearning model.

13. The system of claim 12, wherein fine-tuning the machine unlearning model comprises determining a data impact factor Rᵢ for each slice comprising data of the specific subset of data.

14. The system of claim 13, wherein each of the data impact factors Rᵢ for each respective slice comprising data of the specific subset of data are normalized and applied as a weight to a respective constituent model M_{S} when fine-tuning the SISA unlearning model.

15. A computer program product comprising a computer readable storage medium having program instructions embodied therewith, the program instructions executable by one or more processors to cause the one or more processors to perform operations comprising:
receiving a data removal request identifying, for removal, a specific subset of data from an original training data set;
building an optimal model by minimizing a prediction error over the original training data set;
determining a loss function that measures a difference between a first prediction of the optimal model when trained with the original training data set and a known ground truth;
determining an impact factor that measures a difference between the first prediction of the optimal model and a second prediction of the optimal model when trained with a sanitized training data set against the known ground truth, wherein the sanitized training data set comprises remaining data after removing the specific subset of data from the original training data set; and
fine-tuning a machine unlearning model on the impact factor to quantify an impact of removing the specific subset of data from the original training data set.

16. The computer program product of claim 15, wherein minimizing the prediction error over the original data comprises minimizing a regularized empirical risk.

17. The computer program product of claim 15, wherein the machine unlearning model comprises a sharded, isolated, sliced, aggregated (SISA) unlearning model.

18. The computer program product of claim 17, wherein the SISA unlearning model divides the original training data set into s data splits, wherein each of the s data splits are further split into r slices, and wherein the SISA unlearning model comprises a plurality of constituent models M_{S}, each trained on a unique slice.

19. The computer program product of claim 18, wherein the specific subset of data comprises data on at least one slice of the SISA unlearning model.

20. The computer program product of claim 19, wherein fine-tuning the machine unlearning model comprises determining a data impact factor Rᵢ for each slice comprising data of the specific subset of data.
